(19) United States
(12) Patent Application Publication
(10) Pub. No.: US 2014/0059095 A1
(43) Pub. Date: Feb. 27, 2014

(54) SYSTEM AND METHOD FOR MEAN ESTIMATION FOR A TORSO-HEAVY TAIL DISTRIBUTION

(71) Applicants: Greg D. Adams, Bozeman, MT (US); Timothy W. Amato, Novato, CA (US); Kumar R. Dandapani, San Francisco, CA (US); Yiping Dou, San Jose, CA (US); Gurudev Karanth, San Carlos, CA (US); Anthony Douglas Thrall, Mountain View, CA (US); Mithun Yarlagadda, San Jose, CA (US)

(72) Inventors: Greg D. Adams, Bozeman, MT (US); Timothy W. Amato, Novato, CA (US); Kumar R. Dandapani, San Francisco, CA (US); Yiping Dou, San Jose, CA (US); Gurudev Karanth, San Carlos, CA (US); Anthony Douglas Thrall, Mountain View, CA (US); Mithun Yarlagadda, San Jose, CA (US)

(73) Assignee: eBay Inc., San Jose, CA (US)

(21) Appl. No.: 13/590,934

(22) Filed: Aug. 21, 2012

(51) Int. Cl. G06F 7/00

(52) U.S. Cl. 708/207; 708/200

(57) ABSTRACT

In various example embodiments, systems and methods for estimating the mean of a dataset having a fat tail. Data sets may be partitioned into components, a “torso” component and a “tail” component. For the “tail” component of the data set a more efficient estimator can be obtained (versus the traditionally calculated mean) by using the tail data to estimate parameters for a specific distribution and then deriving the mean from the estimated parameters. The estimated mean from the torso and the estimated mean from the tail may then be combined to obtain the estimated mean for the full data. This can be applied to gross merchandise bought (GMB) by various samples of visitors and apply the experience that was provided to the sample with the highest GMB to all visitors to increase gross revenue.

### TECHNICAL FIELD

Example embodiments of the present disclosure relate generally to the field of computer technology and, more specifically, to providing and using a mean from a heavy tail distribution

### BACKGROUND

Websites provide a number of publishing, listing, and price-setting mechanisms whereby a publisher (e.g., a seller) may list or publish information concerning items for sale on its site, and where a visitor may view items on the site. The experience of the visitor may vary based on the user interface provided. In one instance, one sample of visitors to the site may be a different experience than another sample of visitors, perhaps by using a different search algorithm to rank products listed.

### BRIEF DESCRIPTION OF DRAWINGS

Various ones of the appended drawings merely illustrate example embodiments of the present disclosure and are not to be considered to be limiting its scope.

FIG. 1 is a block diagram illustrating an example embodiment of a network architecture of a system used to identify items depicted in images.

FIG. 2 is a block diagram illustrating an example embodiment of a publication system.

FIG. 3 is a graphical illustration of a heavy tail distribution and a normal tail distribution.

FIG. 4 is a graphical illustration of torso and tail components of example data.

FIG. 5 is a graphical illustration of the mean of a torso component, the mean of a tail component, and the combined mean of a torso component and of a tail component.

FIG. 6 is a block diagram illustrating, vertically, an example embodiment of a mean estimation engine and, horizontally, a swim lane flow chart describing operation of the example embodiment.

FIG. 7 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide an understanding of various embodiments of the inventive subject matter. It will be evident, however, to those skilled in the art that embodiments of the disclosed subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a network-based publication environment, the embodiments are given merely for clarity in disclosure. Thus, any type of electronic publication, electronic commerce, or electronic business system and method, including various system architectures, may employ various embodiments of the listing creation system and method described herein and be considered as being within a scope of the example embodiments. Each of a variety of example embodiments is discussed in detail below.

Example embodiments described herein provide systems and methods to provide improved user experience when visiting a publication system site. This may be done by determining from data sets of the publication system's data logs of visitors, using the appropriate analytics, the “gross merchandise bought” on the site, referred to herein “GMB.” GMB may be viewed as an indicator of total gross revenue for the site. In order to maximize the probability of increased gross revenue, one sample of visitors to the site may be given a different user experience than another sample of visitors. For example, different search algorithms may be used to rank products listed, for different samples of visitors. The sample with the highest mean gross revenue would be considered to have the best site experience, and that site experience could then be applied to all visitors to the site going forward as a method of achieving improved revenue.

GMB may be estimated using the GMB dataset mean, a statistic that is subject to great variability and thus usually requires a huge volume of test data to achieve required precision. Sampling distributions that are more tightly distributed are said to be more “efficient” than sampling distributions that are more spread out, and the more efficient a sampling distribution is, the fewer observations that are needed in a sample to get a reliable estimate of the mean. In short, if there is an efficient estimator for the mean, discussed in more detail below, there is less concern about the estimated means varying significantly from one sample to the next solely from random sampling error.

Data sets may be partitioned into two subgroups (or “components”), a “torso” component and a “tail” component. For the “tail” component of the data a more efficient estimator can be obtained (versus the traditionally calculated mean) by using the tail data to estimate parameters from a specific distribution and then deriving the mean from the estimated parameters. The estimated mean from the torso and the estimated mean from the tail may then be combined to obtain the estimated mean for the full data. Because there is now a more efficient estimator for the tail, a more efficient estimator for the full distribution is obtained. This can be applied to gross merchandise bought by various samples of visitors and apply the experience that was provided to the sample with the highest GMB to all visitors to increase gross revenue.

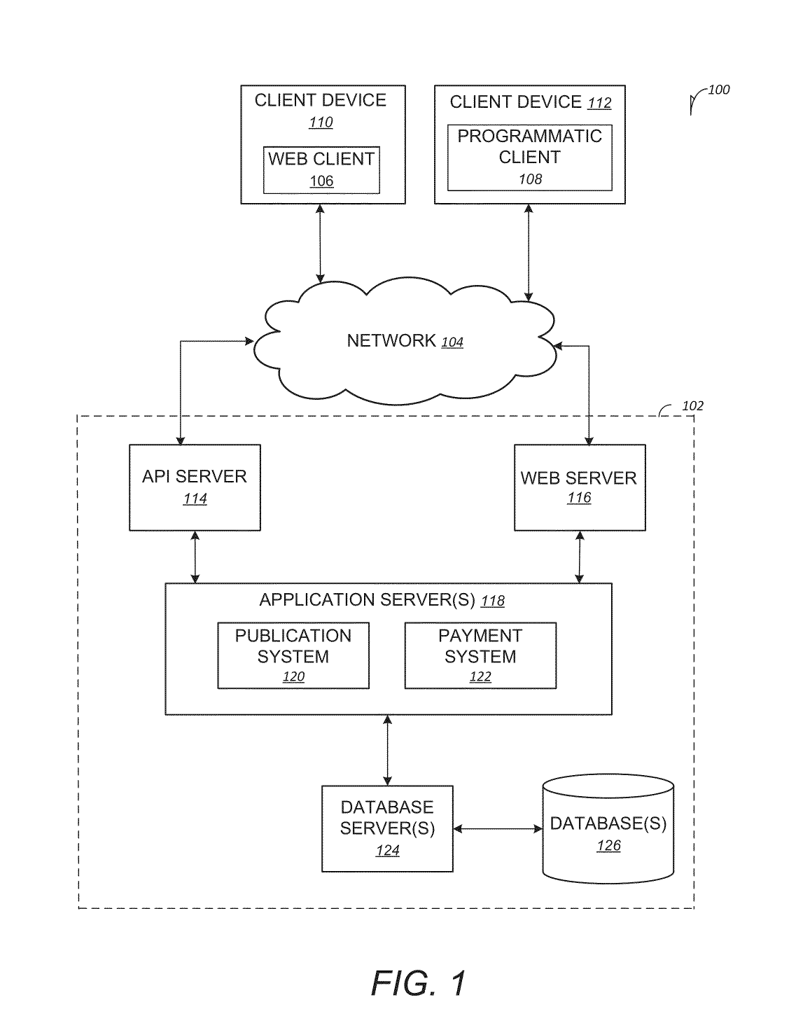

With reference to FIG. 1, an example embodiment of a high-level client-server-based network architecture 100 to provide content based on an image is shown. A networked system 102, in an example form of a network server-side functionality, is coupled via a communication network 104 (e.g., the Internet, wireless network, cellular network, or a Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In some embodiments, the client devices 110 may comprise or be connectable to an image capture device (e.g., camera). The client device 110 may also comprise a voice recognition module (not shown) to receive audio input and a display module (not shown) to display information (e.g., in the form of user interfaces). In further embodiments, the client device 110 may comprise one or more of a touch screen, an accelerometer, and a Global Positioning System (GPS) device.

An Application Program Interface (API) server 114 and a web server 116 are coupled to, and provide programmatic and web interfaces respectively to, one or more application servers 118. The application servers 118 host a publication system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or database(s) 126. In one embodiment, the databases 126 may comprise a knowledge database that may be updated with content, user preferences, and user interactions (e.g., feedback, surveys, etc.).

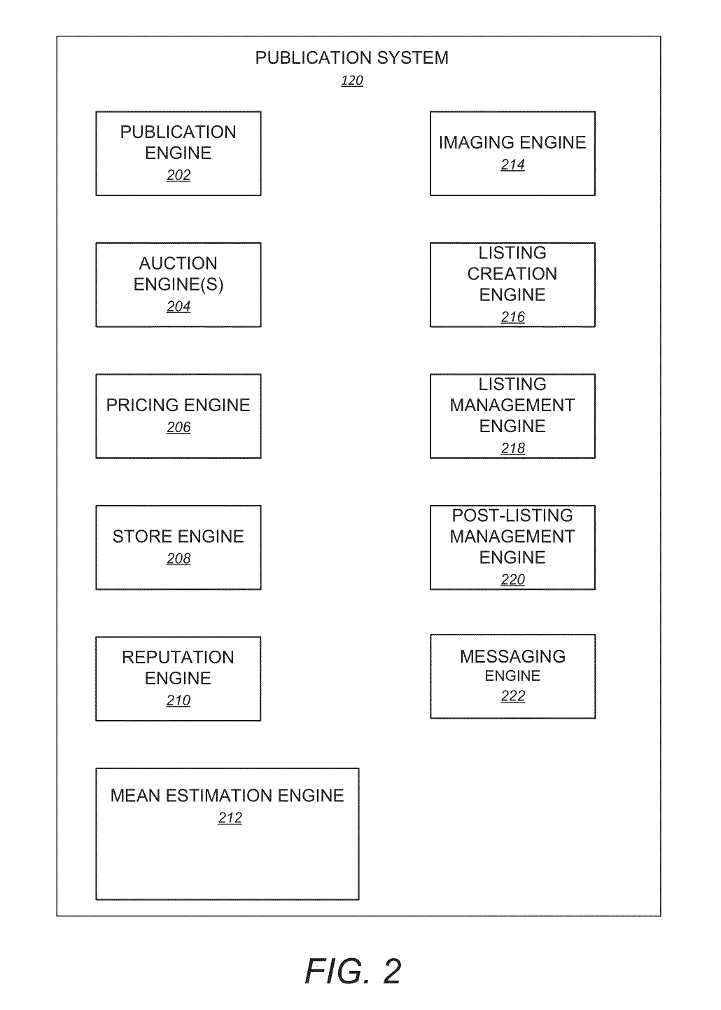

The publication system 120 publishes content on a network (e.g., the Internet). As such, the publication system 120 provides a number of publication and marketplace functions and services to users that access the networked system 102. The publication system 120 is discussed in more detail in connection with FIG. 2. While the publication system 120 is discussed in terms of a marketplace environment, it is noted that the publication system 120 may be associated with a non-marketplace environment.

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the publication system 120. The payment system 122 also facilitates payments from a payment mechanism (e.g., a bank account, PayPal account, or credit card) for purchases of items via the network-based marketplace. While the publication system 120 and the payment system 122 are shown in FIG. 1 to both form part of the networked system 102, it will be appreciated that, in alternative embodiments, the payment system 122 may form part of a payment service that is separate and distinct from the networked system 102.

While the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

Referring now to FIG. 2, an example block diagram illustrating multiple components that, in one example embodiment, are provided within the publication system 120 of the networked system 102 (see FIG. 1), is shown. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more database(s) 126 via the one or more database servers 124, both shown in FIG. 1.

In one embodiment, the publication system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more auction engines 204 that support auction-format listing and price setting mechanisms (e.g., English, Dutch, Chinese, Double, reverse auctions, etc.). The various auction engines 204 also provide a number of features in support of these auction-format listings, such as a reserve price feature whereby a seller may specify a reserve price in connection with a listing and a proxy-bidding feature whereby a bidder may invoke automated proxy bidding.

A pricing engine 206 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and may allow a buyer to purchase goods or services, which are also being offered for sale via an auction, for a fixed price that is typically higher than a starting price of an auction for an item.

A store engine 208 allows a seller to component listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 210 allows users that transact, utilizing the networked system 102, to establish, build, and maintain reputations. These reputations may be made available and published to potential trading partners. Because the publication system 120 supports person-to-person trading between unknown entities, users may otherwise have no history or other reference information whereby the trustworthiness and credibility of potential trading partners may be assessed. The reputation engine 210 allows a user, for example through feedback provided by one or more other transaction partners, to establish a reputation within the network-based publication system over time. Other potential trading partners may then reference the reputation for purposes of assessing credibility and trustworthiness.

Mean estimation in the network-based publication system may be facilitated by a means estimation engine 212. For example, broad operation of the mean estimation engine 212 would include loading into a server experimental GMB data that includes a heavy tail, dividing the data into components, and defining the tail component. The random sampling may be with replacement. Distribution moments may be calculated and these moments may be used to calculate the moments for the combined distribution. A standard error may be calculated and, if desired, an output simulation summary may be generated.

Continuing with a discussion of FIG. 2, in order to make listings available via the networked system 102 visually informing and attractive, the publication system 120 may include an imaging engine 214 that enables users to upload images for inclusion within listings and to incorporate images within viewed listings. The imaging engine 214 also receives image data from a user and utilizes the image data to identify an item depicted or described by the image data.

A listing creation engine 216 allows sellers to conveniently author listings of items. In one embodiment, the listings pertain to goods or services that a user (e.g., a seller) wishes to transact via the publication system 120. In other embodiments, a user may create a listing that is an advertisement or other form of publication.

A listing management engine 218 allows sellers to manage such listings. Specifically, where a particular seller has authored or published a large number of listings, the management of such listings may present a challenge. The listing management engine 218 provides a number of features (e.g., auto-relisting, inventory level monitors, etc.) to assist the seller in managing such listings.

A post-listing management engine 220 also assists sellers with a number of activities that typically occur post-listing. For example, upon completion of an auction facilitated by the one or more auction engines 204, a seller may wish to leave feedback regarding a particular buyer. To this end, the post-listing management engine 220 provides an interface to the reputation engine 210 allowing the seller to conveniently provide feedback regarding multiple buyers to the reputation engine 210.

A messaging engine 222 is responsible for the generation and delivery of messages to users of the networked system 102. Such messages include, for example, advising users regarding the status of listings and best offers (e.g., providing an acceptance notice to a buyer who made a best offer to a seller). The messaging engine 222 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX).

Although the various components of the publication system 120 have been defined in terms of a variety of individual modules and engines, a skilled artisan will recognize that many of the items can be combined or organized in other ways. Furthermore, not all components of the publication system 120 have been included in FIG. 2. In general, components, protocols, structures, and techniques not directly related to functions of example embodiments (e.g., dispute resolution engine, loyalty promotion engine, personalization engines, etc.) have not been shown or discussed in detail. The description given herein simply provides a variety of example embodiments to aid the reader in an understanding of the systems and methods used herein.

### Application of Embodiments of Mean Estimation for a Torso-Heavy Tail Distribution in the Example Network Architecture

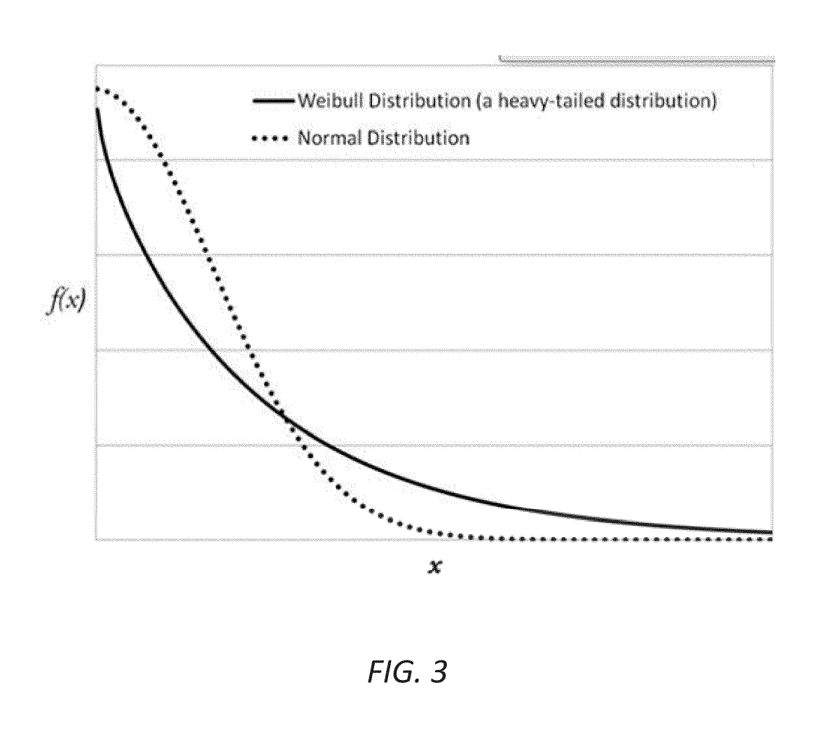

FIG. 3 illustrates tails for a normal distribution and for a heavy-tailed distribution (in this case, a Weibull distribution). Informally, a “heavy-tailed” distribution is one in which the tail is “thicker” than a normal distribution's tail. A more formal definition of “heavy-tailed” distributions is that heavy-tailed distributions are those in which one or both tails of the distribution are not exponentially bounded. The illustration shows that the non normal distribution has heavier tails than the normal.

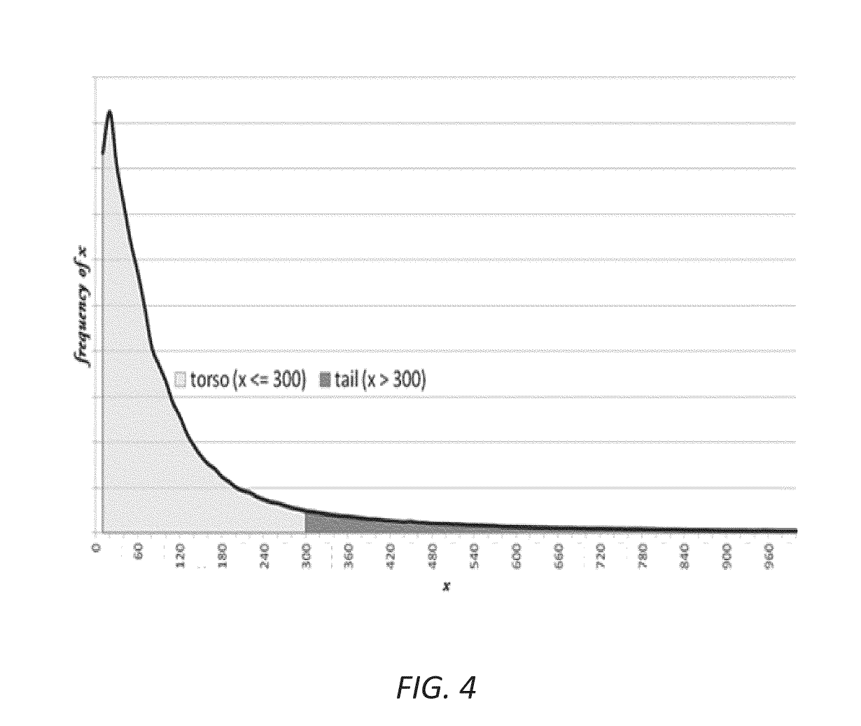

FIG. 4 is a histogram of the GMB data discussed previously. The vertical axis is the frequencies of the various GMB values. The horizontal axis is the actual dollar amounts of GMB. Low dollar amounts that are observed with greater frequency are “taller” when measured on the vertical axis since there are more of them. Low dollar amounts that are observed with less frequency are “shorter” when measured on the vertical axis. Generally, higher dollar amounts of purchases occur with less frequency than lower dollar amounts of purchases in the GMB dataset, and therefore higher dollar amounts tend to comprise the tail of the function of FIG. 4. GMB data is regularly available from publication system data logs and may be pulled from the data warehouse storage and loaded into a server for processing as described in greater detail below. The “torso” and “tail” components, loosely defined, are illustrated for an example set of data. In this case, the cut-off between torso and tail is set to the example of $300. Observations above $300 comprise the “tail,” and the rest of the positive data make up the “torso.” The cut-off defining the components may be chosen to jointly satisfy objectives such as minimizing variance and bias by use of an RMSE (Square Root of MSE) or MSE criterion without the square root operation. RMSE=sqrt(var)+(bias)̂2 so if an estimator is unbiased then (bias)}̂2=0 so the estimator is a minimum variance unbiased estimator. This is clear because of jointly minimizing (bias)̂2 and variance.

There is nothing significant or special about the torso, per se, in the context of this patent. What is significant and noteworthy is that the data can be split into a “torso” component and a “tail” component, a parametric fitting can be applied to the tail data that provides a more efficient estimate of the tail mean than is traditionally estimated, and then the estimates of the torso mean and tail mean can be combined to get an estimate of the mean for the full data that is more efficient than the traditionally estimated mean of the full data. The parametric fitting of the tail may be done by standard maximum likelihood estimation methods that require maximization of a nonlinear function by a derivative based algorithm. One algorithm that may be used is the Newton-Raphson method. The Newton-Raphson algorithm is a method for solving a nonlinear optimization problem based upon optimizing a quadratic approximation of the function (the “maximand”) using first and second derivatives. The quadratic approximation to the function is a second order Taylor Series expansion of the function around some initial estimate. This procedure is iterated to convergence with the estimates produced at the final iteration serving as the maximum likelihood estimates of the Weibull (in the current instance) fit to the tail data. These estimates, which are based upon a numerical or analytical evaluation of the derivatives of the loglikelihood function at the point of convergence, form the basis for computing the mean and variance of the tail data. The “fitting” of the torso is just a simple calculation of the standard arithmetic mean and variance/standard error of that segment of the data. The method discussed results in significantly smaller sample sizes achieving essentially the same statistical power as from larger samples that use traditional techniques.

The partitioning of a data set, here GMB, into components may be done by selecting a fixed cut-off value for the “torso” and “tail” segments (e.g. $300) and putting all values greater than $300 into the “tail”. In an alternate embodiment, the cut point may be determined empirically by selecting a value that jointly minimizes bias (squared) and variance. This latter quantity is called Mean Squared Error by statisticians and serves as a criterion by which cut-points can be empirically selected for the torso and tail components since a fixed cut-point will not be optimal for all datasets.

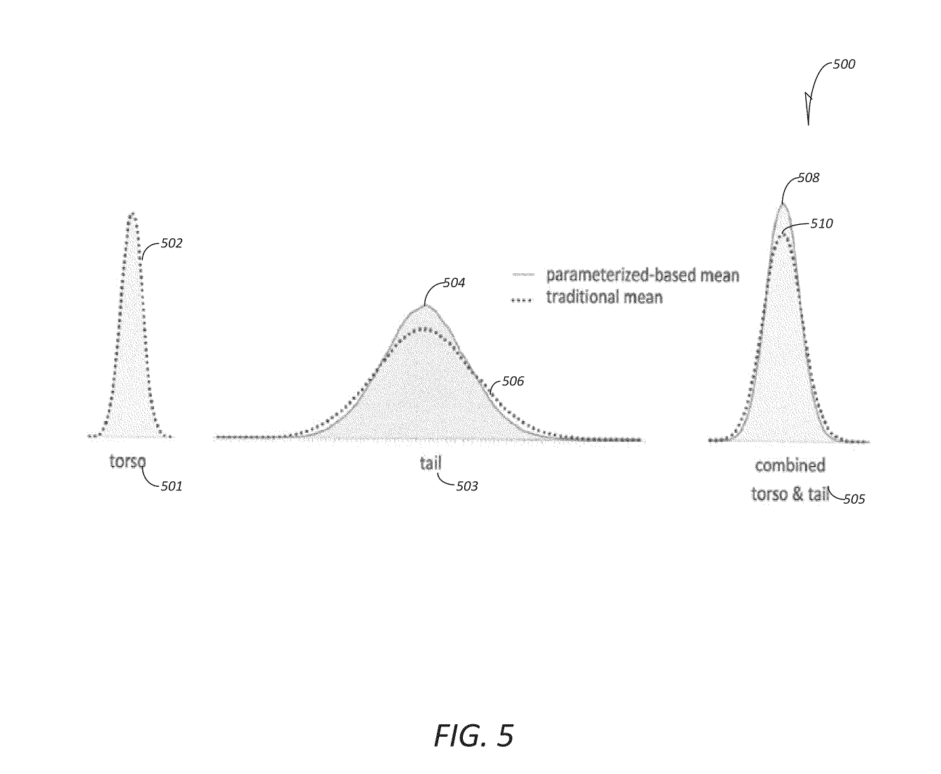

FIG. 5 describes the mean estimation process and the attendant gains in efficiency. If a sample from the “torso” part of the data in FIG. 4, were calculated and the process then repeated thousands of times, the result would be a distribution of thousands of means, with each mean a little different from the others due to sampling error. The distribution of all those means is viewed as the “sampling distribution.” Even though the data for the “torso” in FIG. 4 is skewed, the sampling distribution for the torso 501 in FIG. 5 is bell-shaped, or normally distributed, as at 502. Sampling distributions that are more tightly distributed are said to be more “efficient” than sampling distributions that are more spread out, and the more efficient a sampling distribution is, the fewer observations that are needed in a sample to get a reliable estimate of the mean. If an efficient estimator can be used there is less concern that the means will vary significantly from one sample to the next solely from random sampling error. An estimator may be viewed as a process for combining or using sample data in a way that gives accurate and precise estimates of parameters that are of interest. These may be, for example, measures of central tendency or spread, or even some other quantity of interest like skewness. The torso-tail method is one possible way of combining or using the sample data to estimate these parameters. The parameters of interest are means/averages of GMB from experiments and the “lift” associated with each experiment. Lift is defined as

$$\frac{test mean - control mean}{control mean}$$

$$or$$

$$\frac{test mean}{control mean} - 1$$

In other words, when multiplied by one-hundred (100), lift gives a percent change due to treatment. It has been shown by analyses that the torso-tail estimator improves accuracy and precision when compared with other estimators.

As mentioned above, for the “tail” component of the data a more efficient estimator can be obtained (versus the traditionally calculated mean) by using the tail data to estimate parameters for a specific distribution and then deriving the mean from the estimated parameters. This can be seen from tail 503 of FIG. 5 by the “tighter” distribution for the parametrically-based mean 504 versus the traditional mean 506 (which is normally distributed). The means from the torso and the tail may then be combined to get the mean 508 for the full data, that is, for the combined torso and tail 505. This mean 508 is more efficient than the mean 510 estimated by a more traditional method. That is, because there is now a more efficient estimator for the tail, a more efficient estimator for the full distribution is obtained than from a more traditional method. This can be applied to gross merchandise bought by various samples of visitors and apply the experience that was provided to the sample with the highest GMB to all visitors to increase gross revenue. Analyses have found that efficiency (or reduction in the standard errors in the context of this discussion) can improve anywhere from eight percent (8%) to twenty percent (20%) depending upon the dataset used. The mean is used for testing whether an experimental treatment generated more revenue, and whether this increase was statistically significant. This is done for each experiment running on the site. If, for example, there are ten experiments running, each for different site experiences, there will be an estimate and test models for each of the ten different experiments. As discussed above, data set with the highest mean gross revenue would be considered to have the better site experience, and that site experience may then be applied to all visitors to the site going forward.

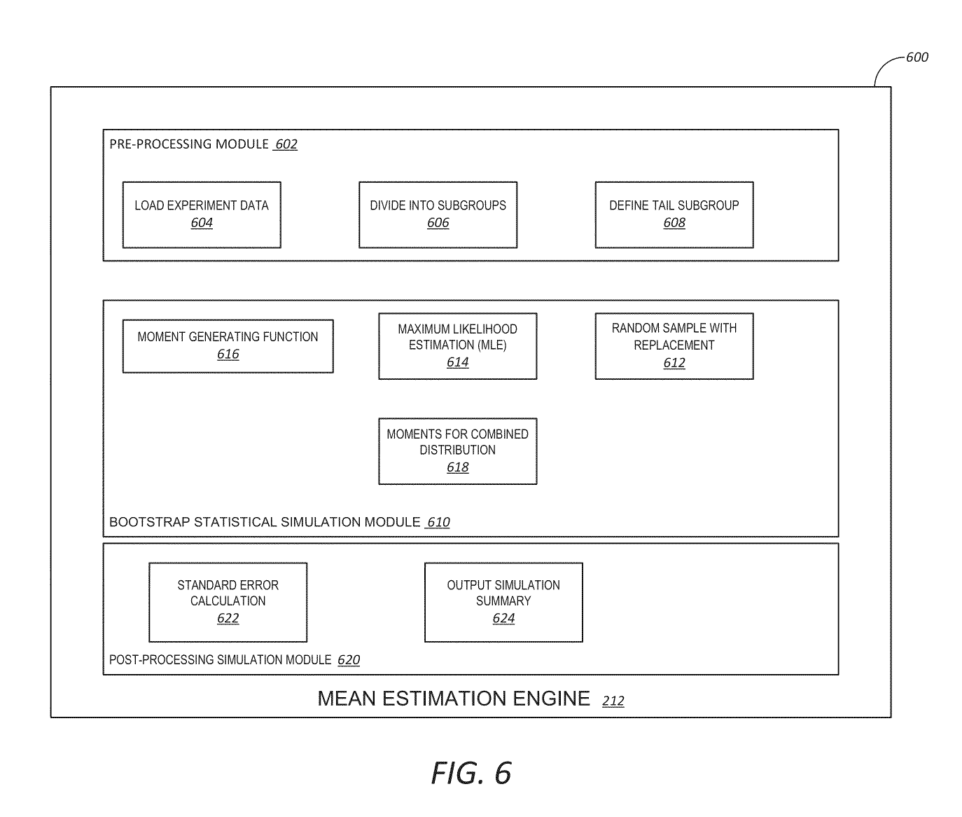

FIG. 6 illustrates, vertically, one embodiment of the mean estimation engine 212 of FIG. 2. Mean estimation engine 212 is seen in this embodiment to comprise pre-processing module 602, bootstrap statistical simulation module 610, and post-processing simulation module 620. FIG. 6 may also be viewed, horizontally, as a swim lane flow chart used to describe the operation of the embodiment.

In FIG. 6 preprocessing module 602 at step 604 loads experiment data, such as a dataset from the publication system's data logs, into server 124 of FIG. 1 as discussed above. At step 606 the data set is divided into components, in this embodiment a torso component and a tail component, as seen in FIG. 4. This may be done, as discussed above, by setting the cut point of FIG. 4 to appropriate amounts or, alternatively, the cut point may be determined empirically by selecting a value that jointly minimizes bias (squared) and variance. At 608 the tail component is defined, as previously discussed. That is, a parametric fitting of the tail may be done by standard maximum likelihood estimation methods that require maximization of a nonlinear function by a derivative based algorithm like Newton Raphson.

The bootstrap statistical simulation module 610 is so-named in accordance with B. Efron & R. J. Tibshirani, An Introduction to the Bootstrap, Chapman & Hall, 1993, p. 5, “the use of the term bootstrap derives from the phrase to pull oneself up by one's bootstrap”. In the current instance, the bootstrap statistical module 610 is letting the data pull itself up by its bootstraps using resampling methods. More practically, the bootstrap is a resampling method used to provide information about the sampling distribution of the mean whereby standard errors and confidence intervals can be calculated by using appropriate resampling methods. Other methods in addition to bootstrapping may be used.

Bootstap statistical simulation module 610 includes random sampling of the data set with replacement 612. In the “bootstrap with replacement” case, after a number is sampled, it is placed back into the mix and can be sampled more than once. Maximum likelihood estimation, 614 which is a statistical estimation procedure that selects those values for the parameters that maximizes the probability of having actually generated the sample data given the distributional assumptions, is performed on the tail data. In other words, maximum likelihood estimation may be viewed as finding those values for the parameters that were most likely to have generated the sample data, given assumptions about the underlying data generating process, which in this case is the Weibull assumption.

Bootstrap statistical simulation module 610 then generates moments for the distribution at moment generating function 612. Moments are statistical quantities of interest associated with any probability distribution. A moment generating function, such as at 612, is a technical mathematical method of calculating moments, which characterize or describe a distribution. For example, the first moment of a distribution is the mean or average value of the distribution, and can be viewed intuitively as a “point of balance”. The second central moment of a distribution is the variance and can be viewed intuitively as a measure of the “spread” of the data. The third central moment is skewness, and the fourth central moment is kurtosis, and so on. These latter moments measure the asymmetry and “fatness” of tails of a distribution, respectively. Stated another way, moment generating functions are a technical mathematical method allowing calculation of these “moments” of interest, but moments like means and variances are substantively important quantities for understanding test results. At 618 are seen moments for the combined distribution which are means and variances from the torso tail method which are of interest since they provide the averages and standard errors needed for evaluating test outcomes.

Post-Processing Simulation Module 620 of mean estimation engine 212 of FIG. 2 then calculates standard errors at 622. At 624 an output simulation summary is provided which is employed to accurately capture the standard error noted at 622.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Storage Medium

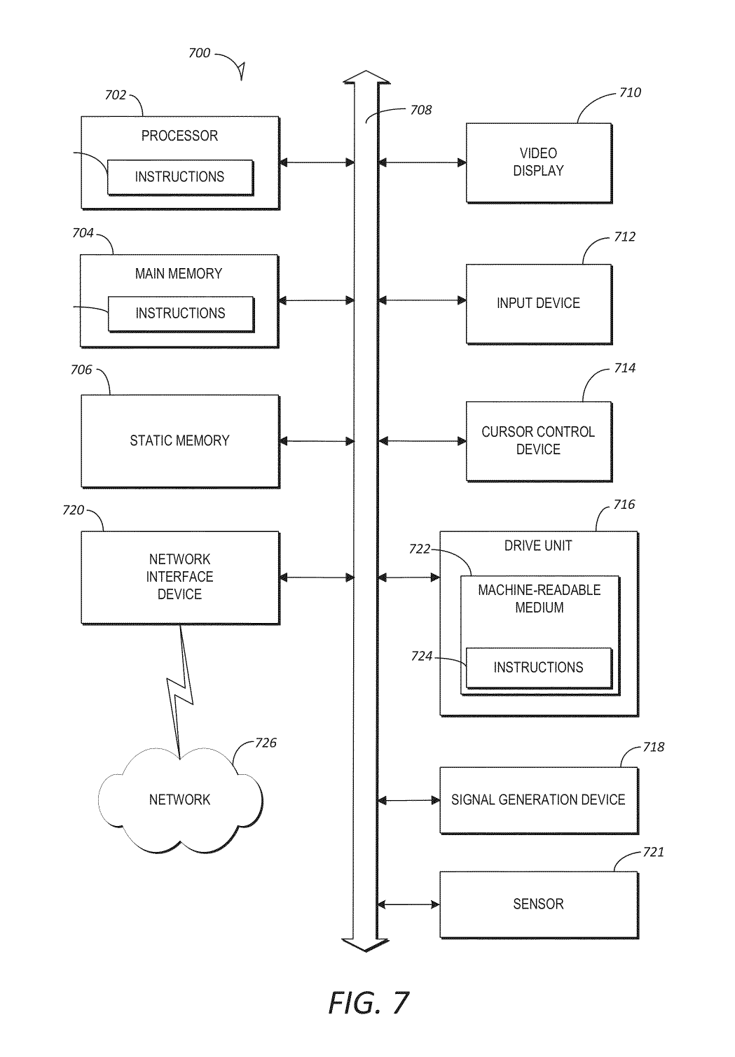

With reference to FIG. 7 an example embodiment extends to a machine in the example form of a computer system 700 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 may include a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). In example embodiments, the computer system 700 also includes one or more of an alpha-numeric input device 712 (e.g., a keyboard), a user interface (UI) navigation device or cursor control device 714 (e.g., a mouse), a disk drive unit 716, a signal generation device 718 (e.g., a speaker), and a network interface device 720.

### Machine-Readable Medium

The disk drive unit 716 includes a machine-readable storage medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, with the main memory 704 and the processor 702 also constituting machine-readable media.

While the machine-readable storage medium 722 is shown in an example embodiment to be a single medium, the term “machine-readable storage medium” may include a single storage medium or multiple storage media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments of the present application, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 724 may further be transmitted or received over a communications network 726 using a transmission medium via the network interface device 720 and utilizing any one of a number of well-known transfer protocols (e.g., Hypertext Transfer Protocol (HTTP)). Examples of communication networks include a local area network (LAN), a wide area network (WAN), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present application. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived there from, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present application. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present application as represented by the appended claims. The specification and drawings are, accordingly, to be regarded in an illustrative rather than a restrictive sense.

What is claimed is:

1. A method of estimating the mean of a heavy-tailed probability distribution comprising:
using at least one computer processor, partitioning the probability distribution into a torso subgroup and a tail subgroup;
using data from the tail subgroup to estimate parameters for a specific distribution; and
deriving the mean of the tail subgroup from the estimated parameters.

2. The method of claim 1 further including estimating the mean of the torso subgroup and assembling the estimated mean of the torso subgroup and the estimated mean of the tail subgroup into an estimated overall-mean of the heavy-tail probability distribution.

3. A method of determining the population mean of heavy-tailed data comprising:
using at least one computer processor, partitioning the data into non-tail and tail components;
estimating the mean and standard error of the non-tail component; and
estimating the mean and standard error of the tail component by fitting a parametrically defined distribution to the tail component, deriving the mean of the tail from the fitted parameter, and estimating the standard error of the mean for the tail.

4. The method of claim 3 further including assembling an overall estimated population mean of the heavy-tailed data as the weighted average of the estimated means of the non-tail and tail components.

5. The method of claim 3 further including combining the estimated standard errors for the non-tail and tail components to get an overall standard error.

6. The method of 3 wherein the parametrically defined distribution is one of the group of distributions consisting of a Weibull distribution, an exponential distribution, a gamma distribution and a Pareto distribution.

7. The method of claim 3 wherein the parametrically defined distribution is selected by trying a series of known statistical parametric distributions and choosing the distribution that shows the greatest reduction in variance while continuing to provide relatively unbiased estimates of the mean of the tail component.

8. The method of claim 3 wherein fitting a parametrically defined distribution to the tail component is performed by standard maximum likelihood estimation methods that employ maximization of a nonlinear function by a derivative based algorithm.

9. The method of claim 8 wherein the algorithm is the Newton-Raphson method.

10. The method of claim 3 wherein partitioning the data into non-tail and tail components includes choosing a cutoff between the non-tail and tail components, the cutoff chosen to minimize variance while keeping estimates of the mean unbiased.

11. The method of claim 3 including using a bootstrap process comprising deriving the mean from the fitted parameters by taking random samples of the data, estimating a parameter, generating moments for the tail distribution using the parameter, and assembling the moments for the combined distribution.

12. The method of claim 11 wherein the parameter is estimated using maximum likelihood estimation.

13. A machine-readable storage device having embedded therein a set of instructions which, when executed by the machine, causes the machine to execute the following operations:
partitioning the probability distribution into a torso subgroup and a tail subgroup;
using data from the tail subgroup to estimate parameters for a specific distribution; and
deriving the mean of the tail subgroup from the estimated parameters.

14. The machine-readable storage device of claim 13 the operations further including estimating the mean of the torso subgroup and assembling the estimated mean of the torso subgroup and the estimated mean of the tail subgroup into an estimated overall-mean of the heavy-tail probability distribution.

15. A machine-readable storage device of determining the population mean of heavy-tailed data comprising:
partitioning the data into non-tail and tail components;
estimating the mean and standard error of the non-tail component; and
estimating the mean and standard error of the tail component by fitting a parametrically defined distribution to the tail component, deriving the mean of the tail from the fitted parameter, and estimating the standard error of the mean for the tail.

16. The machine-readable storage device of claim 15, the operations further including assembling an overall estimated population mean of the heavy-tailed data as the weighted average of the estimated means of the non-tail and tail components.

17. The machine-readable storage device of claim 15, the operations further including combining the estimated standard errors for the non-tail and tail components to get an overall standard error.

18. The machine-readable storage device of 15 wherein the parametrically defined distribution is one of the group of distributions consisting of a Weibull distribution, an exponential distribution, a gamma distribution and a Pareto distribution.

19. The machine-readable storage device of claim 15 wherein the parametrically defined distribution is selected by trying a series of known statistical parametric distributions and choosing the distribution that shows the greatest reduction in variance while continuing to provide relatively unbiased estimates of the mean of the tail component.

20. The machine-readable storage device of claim 15 wherein fitting a parametrically defined distribution to the tail component is performed by standard maximum likelihood estimation methods that employ maximization of a nonlinear function by a derivative based algorithm.

21. The machine-readable storage device of claim 20 wherein the algorithm is the Newton-Raphson method.

22. The machine-readable storage device of claim 15 wherein partitioning the data into non-tail and tail components includes choosing a cutoff between the non-tail and tail components, the cutoff chosen to minimize variance while keeping estimates of the mean unbiased.

23. The machine-readable storage device of claim 15, the operations further including using a bootstrap process comprising deriving the mean from the fitted parameters by taking random samples of the data, estimating a parameter, generating moments for the tail distribution using the parameter, and assembling the moments for the combined distribution.

24. The machine-readable storage device of claim 23 wherein the parameter is estimated using maximum likelihood estimation.

25. A system comprising at least one computer processor configured to:
partition the data into non-tail and tail components;
estimate the mean and standard error of the non-tail component; and
estimate the mean and standard error of the tail component by fitting a parametrically defined distribution to the tail component, deriving the mean of the tail from the fitted parameter, and estimating the standard error of the mean for the tail.

26. The method of claim 25, the at least one computer processor further configured to assemble an overall estimated population mean of the heavy-tailed data as the weighted average of the estimated means of the non-tail and tail components.

27. The method of claim 25, the at least one computer processor further configured to include combining the estimated standard errors for the non-tail and tail components to get an overall standard error.

28. The method of 24 wherein the parametrically defined distribution is one of the group of distributions consisting of a Weibull distribution, an exponential distribution, a gamma distribution and a Pareto distribution.

29. The method of claim 24 wherein the parametrically defined distribution is selected by trying a series of known statistical parametric distributions and choosing the distribution that shows the greatest reduction in variance while continuing to provide relatively unbiased estimates of the mean of the tail component.

30. The method of claim 24 wherein fitting a parametrically defined distribution to the tail component is performed by standard maximum likelihood estimation methods that employ maximization of a nonlinear function by a derivative based algorithm.

31. The method of claim 24 wherein the combining is performed using a weighted average sum.
